(19) United States
(12) Patent Application Publication
(10) Pub. No.: US 2026/0131846 A1
(43) Pub. Date: May 14, 2026

(54) DUST COVER ASSEMBLY, STEERING SHAFT SEALING STRUCTURE, AND VEHICLE

(71) Applicant: BYD COMPANY LIMITED, Shenzhen (CN)

(72) Inventors: Peng ZHANG, Shenzhen (CN); Jintang DING, Shenzhen (CN)

(73) Assignee: BYD COMPANY LIMITED, Shenzhen (CN)

(21) Appl. No.: 19/444,939

(22) Filed: Jan. 9, 2026

Related U.S. Application Data
(63) Continuation of application No. PCT/CN2024/107846, filed on Jul. 26, 2024.

(30) Foreign Application Priority Data
Jul. 31, 2023 (CN) 202310957782.7

(51) Int. Cl. B62D 1/16; B60R 13/06

(52) U.S. Cl. CPC B62D 1/16; B60R 13/06

(57) ABSTRACT

A dust cover assembly for a vehicle is provided. The dust cover assembly includes a cover body, a sealing member, and a bushing. A first end of the cover body includes an opening with an inner wall. The bushing is disposed between the inner wall and the sealing member. The sealing member is configured to sealingly interface with a circumferential surface of a steering shaft of the vehicle. Steering shaft sealing structure and vehicle counterpart embodiments are also contemplated.

The present application is a continuation of International Application No. PCT/CN2024/107846, filed on Jul. 26, 2024, which claims priority to Chinese Patent Application No. 202310957782.7, filed on Jul. 31, 2023, and entitled “DUST COVER ASSEMBLY, STEERING INTERMEDIATE SHAFT SEALING STRUCTURE, AND VEHICLE.” The entire disclosures of the prior applications are hereby incorporated by reference.

### TECHNICAL FIELD

This disclosure pertains to the field of steering shaft sealing technologies, including a dust cover assembly, a steering intermediate shaft sealing structure, and a vehicle.

### BACKGROUND

In the dust cover sealing structure for the steering intermediate shaft in the related technology, support strength of a sealing lip of the sealing member is insufficient, and when a radial error is large, a gap is generated between the sealing lip and the steering intermediate shaft, resulting in reduced sealing performance or even sealing failure.

### SUMMARY

In a related technology, a dust cover sealing structure for a steering intermediate shaft is disclosed, including a steering intermediate shaft, a front wall panel assembly, and a dust cover assembly. The steering intermediate shaft extends through the front wall panel assembly, and the dust cover assembly is disposed around the steering intermediate shaft. The dust cover assembly includes a dust cover and a sealing member, one end of the dust cover is fastened to the front wall panel assembly, and another end of the dust cover is connected to the steering intermediate shaft. The sealing member is disposed in the dust cover and is sealingly connected to the steering intermediate shaft.

A technical problem to be resolved in this disclosure is that, in a dust cover sealing structure for a steering intermediate shaft in a related technology, support strength of a sealing lip is insufficient, and when a radial error is large, a gap is generated between the sealing lip and the steering intermediate shaft, resulting in reduced sealing performance or even sealing failure. Therefore, a dust cover assembly, a steering intermediate shaft sealing structure, and a vehicle are provided.

To address the foregoing technical problem, in one aspect, this disclosure provides a dust cover assembly, including a cover body, a sealing member, and a bushing. One end of the cover body is adapted to be connected to a front cowl panel of a vehicle, and another end of the cover body is provided with a mounting hole. The bushing is disposed between a hole wall of the mounting hole and the sealing member. The sealing member is adapted to be sealingly connected to a steering intermediate shaft of the vehicle.

In some embodiments, a plurality of outer ribs are disposed on an outer circumferential surface of the bushing, and the plurality of outer ribs extend along an axial direction of the bushing; and/or, a plurality of inner ribs are disposed on an inner wall surface of the bushing, and the plurality of inner ribs extend along the axial direction of the bushing.

In some embodiments, the outer rib and the inner rib are disposed on the bushing, the plurality of outer ribs are disposed at equal spacings, the plurality of inner ribs are disposed at equal spacings, and a spacing between adjacent outer ribs is greater than a spacing between adjacent inner ribs.

In some embodiments, an annular mounting groove is formed in the hole wall of the mounting hole, and the bushing and the sealing member are disposed in the mounting groove.

In some embodiments, a first boss and a second boss are disposed on the hole wall of the mounting hole to form the mounting groove.

In some embodiments, an end surface (which may herein be interchangeably referred to as a distal surface) that is of the bushing and that is away from the second boss in the axial direction of the bushing abuts against a surface that is of the first boss and that faces the second boss. An end surface that is of the bushing and that is close to the second boss in the axial direction of the bushing abuts against a surface that is of the second boss and that faces the first boss.

In some embodiments, the bushing includes a bushing body and a flange connected to the bushing body, and the flange protrudes radially inward from the first boss and the second boss.

In some embodiments, the sealing member includes an annular main body portion and a sealing lip. The sealing lip is connected to an inner wall surface of the annular main body portion.

In some embodiments, the annular main body portion is sealingly connected to the inner wall surface of the bushing, and the sealing lip is adapted to be in sealing contact with the steering intermediate shaft.

In some embodiments, the sealing member further includes a second support ring. A groove for mounting the second support ring is formed in the annular main body portion or the sealing lip, and the second support ring is configured to provide support strength for the sealing lip.

In some embodiments, the sealing member further includes a first support ring.

According to some embodiments, an axial boss extending along an axial direction is disposed on the first support ring, an end surface in an axial direction of the sealing lip is provided with a first groove recessed along the axial direction of the sealing lip, and the axial boss is disposed in interference with the first groove; and/or, a radial boss extending along a radial direction of the first support ring is disposed on the first support ring, an inner wall surface of an axial end opening of the annular main body portion is provided with a second groove recessed along a radial direction of the annular main body portion, and the radial boss is disposed in interference with the second groove.

In some embodiments, a first lip and a second lip are formed on a radially inner side of the sealing lip. The first lip and the second lip are located at two opposite ends in an axial direction of the sealing lip. The first lip and the second lip are adapted to be in sealing contact with the steering intermediate shaft.

In some embodiments, a shaft seal inter-lip groove is formed at a position between the first lip and the second lip in an inner wall surface of the sealing lip in the axial direction, and the shaft seal inter-lip groove is recessed radially outward of the sealing member.

In some embodiments, the sealing member further includes a first support ring and a second support ring.

According to some embodiments, an end surface in the axial direction of the sealing lip is provided with a first groove recessed along the axial direction of the sealing lip, the first groove is located in a radially outer side of the first lip, an axial boss is disposed on the first support ring, and the axial boss is disposed in interference with the first groove to support the first lip; and/or, a support ring mounting groove recessed radially is formed in a surface that is of the sealing lip and that is away from the second lip, the second support ring is sleeved on the sealing lip and accommodated in the support ring mounting groove, and the second support ring is used for pressing the second lip tightly against the steering intermediate shaft.

In some embodiments, the bushing is an integrally formed structure.

According to the dust cover assembly in some embodiments of this disclosure, the bushing is disposed between the hole wall of the mounting hole of the cover body and the sealing member, and the sealing member is adapted to be sealingly connected to the steering intermediate shaft of the vehicle. In comparison with the related technology, the sealing member and the bushing are sealed, with no gap. In this way, the sealing member and the cover body are relatively fastened and sealed, and the bushing can well support the sealing member, to improve support strength for the sealing member, so that the sealing member is in closer contact with the steering intermediate shaft, and a radial assembly error of the sealing member is reduced. This improves sealing effect of the dust cover assembly, and reduces a probability of sealing failure of the dust cover assembly.

When the vehicle is in a high-water-level immersion or floating water condition, water is prevented from entering a cockpit through the dust cover assembly. In an example, an IPX7 waterproof rating requirement can be met, meeting requirements of an off-road vehicle for high-water-level immersion wading and floating water condition, thereby improving wading safety of the vehicle.

In another aspect, an embodiment of this disclosure further provides a steering intermediate shaft sealing structure, including a front cowl panel, a steering intermediate shaft, and the foregoing dust cover assembly. A through hole for the cover body to pass through is provided in the front cowl panel, one end of the cover body is sealingly connected to the front cowl panel, the steering intermediate shaft passes through the cover body, and the sealing member is sealingly connected to the steering intermediate shaft.

In some embodiments, a dust cover pressing plate is further included. The cover body includes an outer cylinder body and an inner cylinder body. A cavity is formed inside the outer cylinder body, and one end of the outer cylinder body is sealingly connected to the front cowl panel. The inner cylinder body is connected to another end of the outer cylinder body and extends from an end surface of the other end of the outer cylinder body to the front cowl panel. The dust cover pressing plate is configured to press the end of the outer cylinder body onto the front cowl panel. The bushing is press-fitted in the inner cylinder body, and the sealing member is press-fitted in the bushing.

In some embodiments, the cover body further includes a body sealing portion. The body sealing portion is connected to the end of the outer cylinder body, and the dust cover pressing plate is configured to press the body sealing portion onto the front cowl panel.

In another aspect, an embodiment of this disclosure further provides a vehicle, including the foregoing dust cover assembly or the foregoing steering intermediate shaft sealing structure.

In some embodiments, a dust cover assembly for a vehicle is provided. The dust cover assembly includes a cover body, a sealing member, and a bushing. A first end of the cover body includes an opening with an inner wall. The bushing is disposed between the inner wall and the sealing member. The sealing member is configured to sealingly interface with a circumferential surface of a steering shaft of the vehicle.

In some embodiments, a steering shaft sealing structure is provided. The steering shaft sealing structure includes a front cowl panel, a steering shaft, and a dust cover assembly. The front cowl panel includes a through-hole that is configured to receive the steering shaft. The dust cover assembly includes a cover body, a sealing member, and a bushing. A first end of the cover body includes an opening with an inner wall. A cowl panel end of the cover body is sealingly connected to the front cowl panel. The bushing is disposed between the inner wall and the sealing member. The sealing member is configured to sealingly interface with a circumferential surface of the steering shaft.

In some embodiments, a vehicle is provided. The vehicle includes a steering shaft and a steering intermediate shaft sealing structure. The steering intermediate shaft sealing structure includes a front cowl panel, a dust cover assembly, a sealing member, and a bushing. The front cowl panel includes a through-hole that is configured to receive the steering shaft. The dust cover assembly includes a cover body, a sealing member, and a bushing. A first end of the cover body includes an opening with an inner wall. A cowl panel end of the cover body is sealingly connected to the front cowl panel. The bushing is disposed between the inner wall and the sealing member. The sealing member is configured to sealingly interface with a circumferential surface of the steering shaft.

### BRIEF DESCRIPTION OF DRAWINGS

FIG. 1 is a schematic diagram of a steering intermediate shaft sealing structure according to an embodiment of this disclosure;

FIG. 2 is a cross-sectional view of a dust cover assembly and a steering intermediate shaft according to an embodiment of this disclosure;

FIG. 3 is a cross-sectional view of a dust cover assembly according to an embodiment of this disclosure;

FIG. 4 is a cross-sectional view of a cover body of a dust cover assembly and a dust cover pressing plate according to an embodiment of this disclosure;

FIG. 5 is a schematic diagram of a bushing of a dust cover assembly according to an embodiment of this disclosure;

FIG. 6 is a cross-sectional view of a sealing member of a dust cover assembly according to an embodiment of this disclosure;

FIG. 7 is a cross-sectional view of a first support ring of a sealing member of a dust cover assembly according to an embodiment of this disclosure; and

FIG. 8 is a cross-sectional view of a shaft seal of a sealing member of a dust cover assembly according to an embodiment of this disclosure.

### DETAILED DESCRIPTION

To make technical problems to be resolved, technical solutions, and beneficial effects of this disclosure clearer, the following further describes examples of embodiments of this disclosure with reference to the accompanying drawings. It should be understood that the specific embodiments described herein are merely used to explain this disclosure, and are not intended to limit this disclosure.

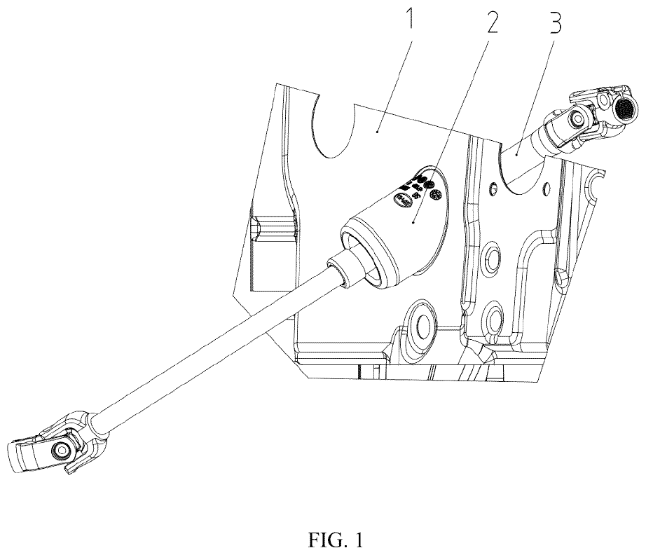

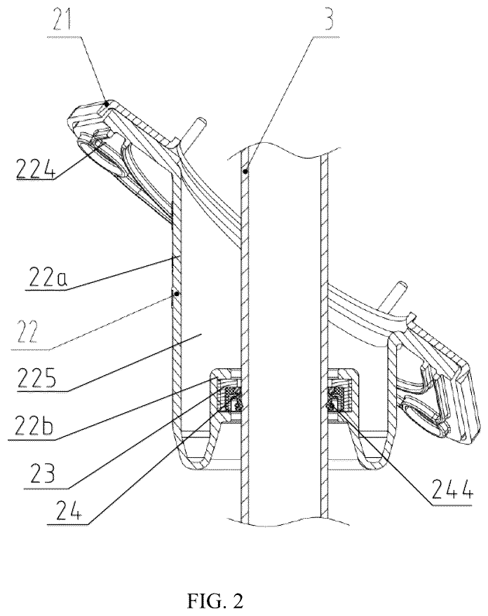

Refer to FIG. 1 to FIG. 8. A dust cover assembly 2 provided in an embodiment of this disclosure includes a cover body 22, a bushing 23, and a sealing member 24. One end of the cover body 22 is adapted to be connected to a front cowl panel 1 of a vehicle, and another end of the cover body 22 is provided with a mounting hole. The bushing 23 is disposed between a hole wall of the mounting hole and the sealing member 24, and the sealing member 24 is adapted to be sealingly connected to a steering shaft, such as a steering intermediate shaft 3, of the vehicle. Both one end and the other end of the cover body 22 may be free ends.

In the dust cover assembly 2 in this embodiment of this disclosure, the bushing 23 is disposed between the hole wall of the mounting hole of the cover body 22 and the sealing member 24, and the sealing member 24 is sealingly connected to the bushing 23. In comparison with the related technology, the bushing 23 and the cover body 22 are sealed, with no gap. In this way, the sealing member 24 and the cover body 22 are relatively fastened and sealed, and the bushing 23 can well support the sealing member 24, to improve support strength for the sealing member 24, so that the sealing member 24 is in a closer contact with the steering intermediate shaft 3, and a radial assembly error of the sealing member 24 is reduced. This improves sealing effect of the dust cover assembly 2, and reduces a probability of sealing failure of the dust cover assembly 2. When the vehicle is in a high-water-level immersion or floating water condition, water is prevented from entering a cockpit through the dust cover assembly 2, which meets, for example, an IPX7 waterproof rating requirement, and requirements of an off-road vehicle for high-water-level immersion wading and floating water condition, thereby improving wading safety of the vehicle.

In addition, the dust cover assembly 2 in this embodiment of this disclosure can further prevent a solid contaminant such as outside dust or other liquid contaminants from entering the cover body 22 and the cockpit.

In an embodiment, a dust cover pressing plate 21 is further included. The cover body 22 includes an outer cylinder body 22a and an inner cylinder body 22b. A cavity 225 is formed inside the outer cylinder body 22a, and one end of the outer cylinder body 22a is sealingly connected to the front cowl panel 1. The inner cylinder body 22b is connected to another end of the outer cylinder body 22a and extends from an end surface of the other end of the outer cylinder body 22a toward the front cowl panel 1. The dust cover pressing plate 21 is configured to press the end of the outer cylinder body 22a onto the front cowl panel 1. The bushing 23 is press-fitted in the inner cylinder body 22b, and the sealing member 24 is press-fitted in the bushing 23.

In an embodiment, the cover body 22 further includes a body sealing portion 224. The body sealing portion 224 is connected to the end of the outer cylinder body 22a, and the dust cover pressing plate 21 is configured to press the body sealing portion 224 onto the front cowl panel 1.

In an embodiment, the cover body 22 is integrally formed by vulcanization. In comparison with a solution in which the cover body 22 and a collar are fastened to each other by adhesive, the process is simpler and sealing reliability is better.

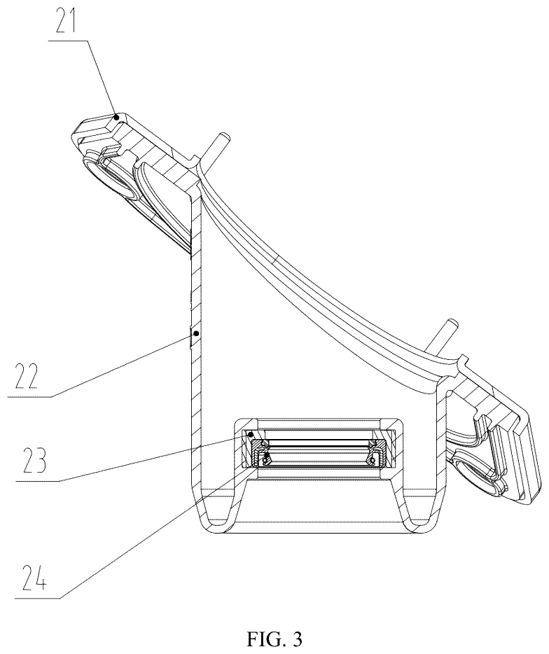

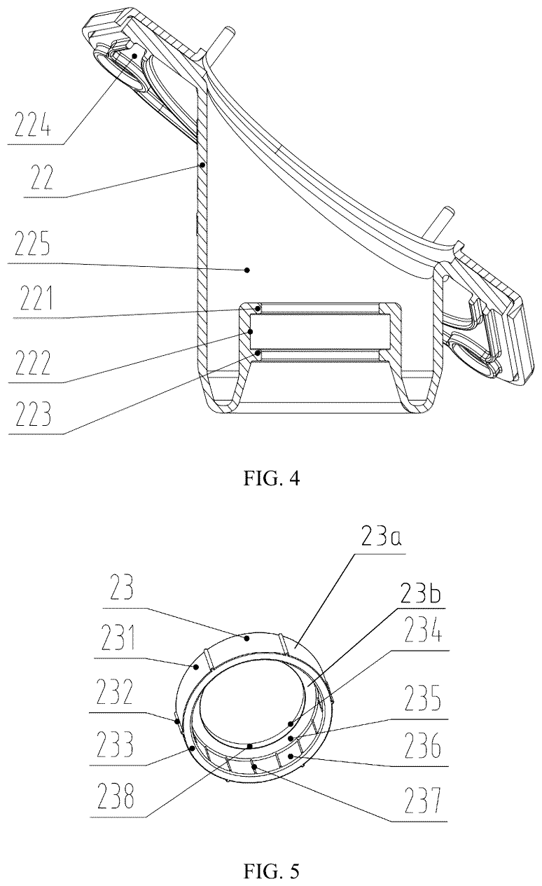

In an embodiment, refer to FIG. 3 and FIG. 4. An annular mounting groove 222 is provided in the hole wall of the mounting hole at the other end of the cover body 22, and the bushing 23 and the sealing member 24 are disposed in the mounting groove 222. Specifically, the annular mounting groove 222 is provided in an inner wall of the inner cylinder body 22b, and the bushing 23 is press-fitted in the mounting groove 222. That is, the bushing 23 and the cover body 22 are mounted in an interference fit. In comparison with a solution in which the bushing and the collar are fastened to each other by adhesive and the sealing member and the collar are fastened to each other by a clamping slot, the assembly process is simple, sealing reliability is improved, and production costs are reduced.

In a steering intermediate shaft sealing structure, when two sealing structures are used for sealing between a sealing member and a steering intermediate shaft 3, that is, both two sealing rings (K-sealing rings) are used, the K-sealing ring, a bushing, and the sealing member are mounted in clearance fit, and water cannot be completely prevented from entering a cover body 22 from the clearance. In the dust cover assembly 2 in this embodiment of this disclosure, the sealing member 24 and the bushing 23 are assembled through interference press-fit, which can better prevent water from entering the cover body 22 through a fitting surface thereof, and has better sealing performance and meets the IPX7 waterproof rating requirement.

In an embodiment, the dust cover pressing plate 21 is formed by stamping a material of DC01 (cold-roll steel sheet), and the body sealing portion 224 of the cover body 22 is firmly mounted on the front cowl panel 1 through fastening connection of a bolt/nut, thereby sealing the dust cover assembly 2 and the front cowl panel 1. In order to improve sealing performance, a rib is disposed on a surface that is of the body sealing portion 224 and that faces the front cowl panel 1.

In an embodiment, the cover body 22 is integrally formed by vulcanization of EPDM (Ethylene Propylene Diene Monomer).

The cavity 225 is used to avoid the steering intermediate shaft 3 and ensure that there is a sufficient safety distance between the cavity 225 and the steering intermediate shaft 3.

In an embodiment, the bushing is an integrally formed structure. For example, the bushing 23 is integrally formed by injection molding of a glass fiber reinforced nylon material.

In an embodiment, refer to FIG. 3 and FIG. 4. A first boss 221 and a second boss 223 are disposed on the hole wall of the mounting hole to form the mounting groove 222. That is, the other end that is of the cover body 22 and that is close to the front cowl panel 1 extends radially inward to the cover body 22, to form the first boss 221, and the other end of the cover body 22 extends radially inward to the cover body 22, to form the second boss 223. Specifically, one end that is of the inner cylinder body 22b and that is close to the front cowl panel 1 extends radially inward to the inner cylinder body 22b, to form the first boss 221. The second boss 223 is located between the first boss 221 and an end portion that is of the cover body 22 and that is away from the front cowl panel 1 in an axial direction of the cover body 22. Specifically, the second boss 223 is located between the first boss 221 and an end that is of the inner cylinder body 22b and that is away from the front cowl panel 1 in the axial direction of the cover body 22. The mounting groove 222 is formed between the first boss 221 and the second boss 223. In this way, a cross-section of the mounting groove 222 is C-shaped, and the first boss 221 and the second boss 223 are in interference fit with the bushing 23, so that the bushing 23 can be well clamped.

In an embodiment, both the first boss 221 and the second boss 223 are annular.

In an embodiment, refer to FIG. 3 to FIG. 5. The bushing 23 is annular. An end surface 234 that is of the bushing 23 and that is away from the second boss 223 in an axial direction abuts against a surface that is of the first boss 221 and that faces the second boss 223. An end surface 233 that is of the bushing 23 and that is close to the second boss 223 in the axial direction abuts against a surface that is of the second boss 223 and that faces the first boss 221. In this way, the bushing 23 is interference-press-fitted in the mounting groove 222.

In an embodiment, refer to FIG. 3 to FIG. 5, a cross-section of the bushing 23 is L-shaped, the bushing 23 includes a bushing body 23a and a flange 23b connected to the bushing body 23a, and the flange 23b protrudes radially inward from the first boss 221 and the second boss 223. The flange 23b is connected to one end that is of the bushing body 23a and that is close to the first boss 221, and extends radially inward to the bushing 23. The flange 23b protrudes from the mounting groove 222, and an end surface that is of the bushing body 23a and that is close to the second boss 223 is located in the mounting groove 222. The flange 23b is configured to abut against a top end surface of the sealing member 24, and a bottom end surface of the sealing member 24 abuts against the second boss 223 to limit axial displacement of the sealing member 24.

An outer circumferential surface 231 of the bushing body 23a, the opposite axial end surface 233 of the bushing 23, and the axial end surface 234 of the bushing 23 are attachment surfaces for mounting with the cover body 22, all mounted by interference fit. The three surfaces form a C-shaped interference fit, so that the bushing 23 is securely and reliably fastened in the cover body 22. A flange bottom surface 235 and an inner wall surface 236 of the bushing body 23a are used for mounting of the inner sealing member 24, to ensure that the sealing member 24 is interference fit inside the flange bottom surface 235 and the inner wall surface 236 of the bushing body 23a, and to prevent solid/liquid contaminants such as water and dust from passing through a fitting surface thereof, thereby achieving sealing effect. A flange inner side surface 238 is radially spaced from the steering intermediate shaft 3 to ensure that the steering intermediate shaft 3 does not interfere with the bushing 23 during rotation.

In an embodiment, refer to FIG. 3 to FIG. 5. A plurality of outer ribs 232 are disposed on the outer circumferential surface 231 of the bushing body 23a, and the plurality of outer ribs 232 extend along the axial direction of the bushing 23. The outer rib 232 further provides an anti-rotation function for the interference fit mounting between the bushing 23 and the cover body 22, thereby avoiding relative rotation between the bushing 23 and the cover body 22, and increasing sealing reliability. A plurality of inner ribs 237 are disposed on the inner wall surface 236 of the bushing 23, and the plurality of inner ribs 237 extend along the axial direction of the bushing 23. The inner rib 237 further provides an anti-rotation function for the interference fit mounting between the bushing 23 and the sealing member 24, thereby avoiding relative rotation between the bushing 23 and the sealing member 24, and increasing sealing reliability.

The outer rib 232 may be recessed into the cover body 22 to seal the cover body 22 and the bushing 23. The inner rib 237 may be recessed into the sealing member 24 to seal the bushing 23 and the sealing member 24.

In an embodiment, refer to FIG. 5. The plurality of outer ribs 232 are arranged at equal spacings, the plurality of inner ribs 237 are arranged at equal spacings, and a spacing between adjacent outer ribs 232 is greater than a spacing between adjacent inner ribs 237. In an example, the spacing between the adjacent outer ribs 232 is substantially greater than the spacing between the adjacent inner ribs 237.

In an embodiment, the sealing member 24 includes an annular main body portion 242 and a sealing lip 2422. The sealing lip 2422 is connected to an inner wall surface of the annular main body portion 242 and extends radially inward to the annular main body portion 242. The annular main body portion 242 is sealingly connected to the inner wall surface of the bushing 23.

In an embodiment, the sealing member 24 further includes a second support ring 243. A groove for mounting the second support ring 243 is formed in the annular main body portion 242 or sealing lip 2422, and the second support ring 243 is configured to provide support strength for the sealing lip 2422.

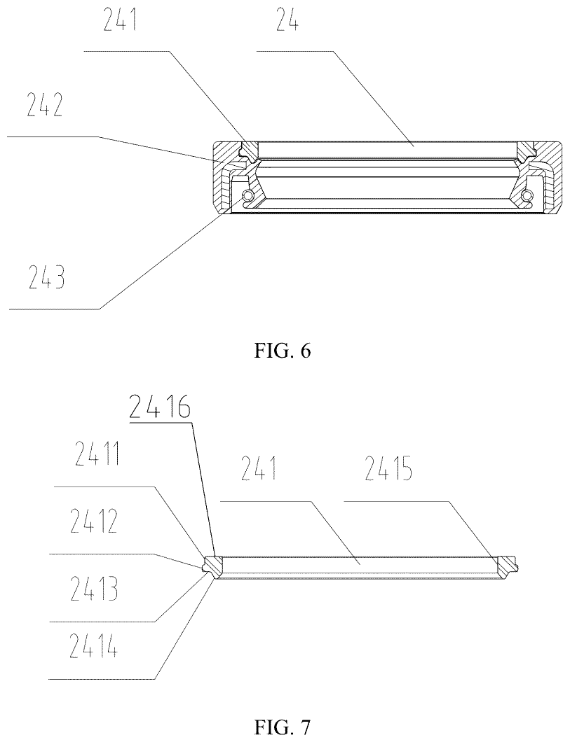

In an embodiment, refer to FIG. 6 to FIG. 8. The sealing member 24 further includes a first support ring 241, and an axial boss 2414 extending along an axial direction is disposed on the first support ring 241. One end surface in an axial direction of the sealing lip 2422 is provided with a first groove 24214 recessed along the axial direction of the sealing lip 2422, and the axial boss 2414 is disposed in interference with the first groove 24214, to limit radial movement of the first support ring 241 and the annular main body portion 242. The first support ring 241 is assembled in interference with an opening at one end that is of the annular main body portion 242 and that is close to the second boss 223, and the annular main body portion 242 is assembled in interference with the bushing 23. The sealing member 24 and the bushing 23 are mounted by interference fit, and an interference amount effectively prevents solid/liquid contaminants such as water and dust from entering the cover body 22 and the cockpit through a mounting fitting surface between the sealing member 24 and the bushing 23, thereby achieving sealing effect. The first support ring 241 is integrally formed by injection molding of a glass fiber reinforced nylon material.

In an embodiment, the first support ring 241 is connected to an end that is of the sealing lip 2422 and that is close to the second boss 223, to provide support strength for the sealing lip 2422.

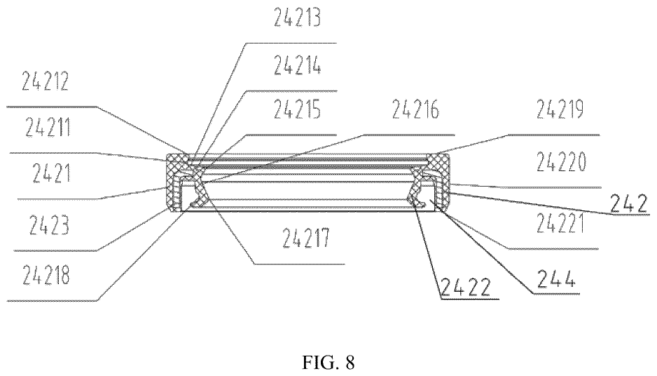

In an embodiment, refer to FIG. 6 and FIG. 8. The annular main body portion 242 includes a body portion 2421 and a holder 2423. The body portion 2421 wraps the holder 2423, and the holder 2423 is configured to enhance strength of the annular main body portion 242 and support the sealing lip 2422.

In an embodiment, refer to FIG. 6 and FIG. 8. The sealing lip 2422 is annular, and a first lip 24215 and a second lip 24217 are formed on a radially inner side of the sealing lip 2422. The first lip 24215 and the second lip 24217 are located at two opposite ends in the axial direction of the sealing lip 2422. The first lip 24215 is connected to one end that is of the inner wall surface of the annular main body portion 242 and that is close to the first support ring 241, and extends to the inside of the annular main body portion 242. The second lip 24217 is connected to one end that is of the inner wall surface of the annular main body portion 242 and that is away from the first support ring 241, and protrudes toward the inside of the annular main body portion 242. Double sealing between the sealing member 24 and the steering intermediate shaft 3 can be achieved through sealing contact between the two lips and the steering intermediate shaft 3.

In an embodiment, refer to FIG. 8. A shaft seal inter-lip groove 24216 is formed at a position between the first lip 24215 and the second lip 24217 in an inner wall surface of the sealing lip 2422 in the axial direction, and the shaft seal inter-lip groove 24216 is recessed radially outward of the sealing member 24. The shaft seal inter-lip groove 24216 is provided to avoid excessive contact between the sealing lip 2422 and the steering intermediate shaft 3 and reduce a rotational torque.

The first groove 24214 is located in a radially outer side of the first lip 24215 to support the first lip 24215.

In an embodiment, refer to FIG. 6 to FIG. 8. The sealing member 24 further includes the first support ring 241 provided with a radial boss 2412. An inner wall surface of an axial end opening of the annular main body portion 242 is provided with a second groove 24211 recessed along a radial direction of the annular main body portion 242. The radial boss 2412 is disposed in interference with the second groove 24211, to limit axial movement of the first support ring 241 and the annular main body portion 242.

Refer to FIG. 6 to FIG. 8. An inner wall surface of an opening at one end that is of the annular main body portion 242 and that is close to the front cowl panel 1 has a support ring mounting side surface 24212 that extends along the axial direction of the annular main body portion 242 and a support ring mounting bottom surface 24213 extending along the radial direction of the annular main body portion 242. The support ring mounting bottom surface 24213 is connected to one end that is of the support ring mounting side surface 24212 and that is away from the first boss 221. The support ring mounting side surface 24212 is provided with a second groove 24211 recessed radially outward of the annular main body portion 242. A surface of the first support ring 241 includes a support ring outer side surface 2411, a support ring top surface 2416, a support ring bottom surface 2413, and a support ring inner side surface 2415. The support ring outer side surface 2411 is connected between the support ring top surface 2416 and an outer edge of the support ring bottom surface 2413. The support ring inner side surface 2415 is connected between the support ring top surface 2416 and an inner edge of the support ring bottom surface 2413. The support ring outer side surface 2411 is provided with the radial boss 2412 that protrudes radially outward of the first support ring 241. The support ring outer side surface 2411 abuts against the support ring mounting side surface 24212, and the support ring bottom surface 2413 abuts against the support ring mounting bottom surface 24213.

In an embodiment, refer to FIG. 6 to FIG. 8. The support ring mounting bottom surface 24213 is provided with the first groove 24214 that is recessed along the axial direction of the annular main body portion 242 away from the front cowl panel 1. The support ring bottom surface 2413 is provided with the axial boss 2414 that protrudes along the axial direction of the first support ring 241 away from the front cowl panel 1. The axial boss 2414 is interference-press-fitted in the first groove 24214, to limit radial movement of the first support ring 241 and the annular main body portion 242.

The first support ring 241 is mounted through an interference fit between the annular main body portion 242 and the support ring outer side surface 2411, the radial boss 2412, the support ring bottom surface 2413, and the axial boss 2414. In addition, the radial boss 2412 performs axial limiting to avoid axial movement of the first support ring 241. In this way, the first support ring 241 is firmly fastened in the annular main body portion 242, and the support ring inner side surface 2415 has a sufficient distance in the radial direction from the steering intermediate shaft 3, to ensure that the steering intermediate shaft 3 does not interfere with the first support ring 241 during rotation.

In an embodiment, the first groove 24214 is located in the radially outer side of the first lip 24215 to support the first lip 24215.

In an embodiment, the dust cover assembly 2 further includes a second support ring 243, and deformation avoidance space 244 is formed between the sealing lip 2422 and the annular main body portion 242. A support ring mounting groove 24218 recessed away from the deformation avoidance space 244 is formed in a surface that is of the sealing lip 2422 and that is away from the second lip 24217. The second support ring 243 is sleeved on the sealing lip 2422 and accommodated in the support ring mounting groove 24218. The second support ring 243 is used for pressing the second lip 24217 tightly against the steering intermediate shaft 3.

In an embodiment, the second support ring 243 is an annular spring. The annular spring is used as a standard part, and a material and a size are selected to ensure that the annular spring provides proper radial clamping force to a position in which the second lip 24217 is radially interference-fitted with the steering intermediate shaft 3. This not only helps meet the IPX7 rating requirement for sealing performance between the second lip 24217 and the steering intermediate shaft 3 but also helps meet a rotational torque specified between the second lip 24217 and the steering intermediate shaft 3. A groove structure of the support ring mounting groove 24218 ensures stable mounting of the annular spring and prevents the annular spring from falling off.

However, in another embodiment, a rubber band, a rubber ring, or an elastic hoop may be used instead of the annular spring.

In an embodiment, the annular main body portion 242 is formed by vulcanization of DC01 L-shaped steel structure liner and NBR (Nitrile Butadiene Rubber, nitrile butadiene rubber) rubber. The holder 2423 is formed by stamping a material of DC01, and a structure is L-shaped, thereby improving strength of the holder 2423. Then, the holder 2423 is used as a liner, and the body portion 2421 made of NBR rubber is vulcanized on the outside of the holder 2423, to obtain the annular main body portion 242. The second groove 24211, the support ring mounting side surface 24212, the support ring mounting bottom surface 24213, and the first groove 24214 are mounting attachment surfaces for interference fit with the first support ring 241. Because the NBR material has good elasticity, the four attachment surfaces: the second groove 24211, the support ring mounting side surface 24212, the support ring mounting bottom surface 24213. and the first groove 24214, have a specific amount of elastic compression in the case of interference fit, to provide sufficient pressing force. In addition, the axial movement of the first support ring 241 is effectively limited through an interference fit between the second groove 24211 and the radial boss 2412, so that the mounting is more reliable. An interference fit between the first groove 24214 and the axial boss 2414 effectively supports radial interference-fit mounting between the first lip 24215 and the steering intermediate shaft 3, and provides specific inward radial pressing force, to ensure sealing performance of the first lip 24215. This helps prevent solid/liquid contaminants such as water and dust from entering the cover body 22 and the cockpit through a mating area between the first lip 24215 and the steering intermediate shaft 3, thereby achieving sealing effect. A position of the first lip 24215 is designed for use with grease, allowing smoother rotation of the steering intermediate shaft 3. Meanwhile, waterproof performance of the first lip 24215 is improved. The NBR material has excellent oil resistance and high wear resistance, so that sealing reliability and durability of the first lip 24215 are better guaranteed. The shaft seal inter-lip groove 24216 is provided to avoid excessive contact between the shaft seal inter-lip groove 24216 and the steering intermediate shaft 3 and reduce a rotational torque. A shaft seal top end surface 24219, a shaft seal outer side surface 24220, and the bushing 23 are connected through a two-sided interference fit, and the NBR material has good elasticity, so that the interference fit between the shaft seal top end surface 24219, the shaft seal outer side surface 24220, and the bushing 23 has sufficient pressing force. This prevents solid/liquid contaminants such as water and dust from entering the cover body 22 and the cockpit through a fitting surface between the annular main body portion 242 and the bushing 23, thereby achieving sealing effect. A shaft seal bottom end surface 24221 is mounted in an interference fit with the second boss 223 of the cover body 22, thereby further stabilizing an axial tight fit between the annular main body portion 242 and the bushing 23, and increasing an axial limit of the annular main body portion 242 relative to the bushing 23. The second lip 24217 is mounted in a radial interference fit with the steering intermediate shaft 3. Combined with radial clamping force provided by the annular spring mounted on the support ring mounting groove 24218 and the grease applied to the second lip 24217, sealing performance between the second lip 24217 and the steering intermediate shaft 3 is increased. This more effectively prevents solid/liquid contaminants such as water and dust from entering the cover body 22 and the cockpit through a mating area between the second lip 24217 and the steering intermediate shaft 3, which meets the IPX7 waterproof rating requirement.

In addition, refer to FIG. 1. An embodiment of this disclosure further provides a steering intermediate shaft sealing structure, including a front cowl panel 1, a steering intermediate shaft 3, and the dust cover assembly 2 in the foregoing embodiment. A through hole for the cover body 22 to pass through is provided in the front cowl panel 1, one end of the cover body 22 is sealingly connected to the front cowl panel 1, the steering intermediate shaft 3 passes through the cover body 22, and the sealing member 24 is sealingly connected to the steering intermediate shaft 3.

Specifically, a gap between the cover body 22 and an inner wall of the through hole is sealed by the body sealing portion 224.

Specifically, the steering intermediate shaft 3 passes through the inner cylinder body 22b, the outer cylinder body 22a, and a dust cover pressing plate 21.

In addition, an embodiment of this disclosure further provides a vehicle, including the dust cover assembly 2 in the foregoing embodiment or the steering intermediate shaft sealing structure in the foregoing embodiment.

The foregoing descriptions are merely examples of embodiments of this disclosure, and are not intended to limit this disclosure. Any modification, equivalent replacement, and improvement, or the like made without departing from the spirit and principle of this disclosure shall fall within the protection scope of this disclosure.

1. A dust cover assembly for a vehicle, the dust cover assembly comprising:
a cover body, a first end of the cover body including an opening with an inner wall;
a sealing member; and
a bushing disposed between the inner wall and the sealing member, wherein the sealing member is configured to sealingly interface with a circumferential surface of a steering shaft of the vehicle.

2. The dust cover assembly of claim 1, wherein a second end of the cover body is configured to be fitted to a front cowl panel of the vehicle.

3. The dust cover assembly of claim 1, wherein the bushing further comprises at least one of:
a plurality of outer ribs disposed on an outer circumferential surface of the bushing and extending along an axial direction of the bushing, or
a plurality of inner ribs disposed on an inner wall surface of the bushing and extending along the axial direction of the bushing.

4. The dust cover assembly of claim 1, wherein
the bushing includes:
a plurality of outer ribs disposed on an outer circumferential surface of the bushing and extending along an axial direction of the bushing, and
a plurality of inner ribs disposed on an inner wall surface of the bushing and extending along the axial direction of the bushing;
the plurality of outer ribs are disposed at first equal spacings;
the plurality of inner ribs are disposed at second equal spacings; and
the first equal spacings are greater than the second equal spacings.

5. The dust cover assembly of claim 1, wherein
an annular groove is formed in the inner wall of the opening, and
the bushing and the sealing member are disposed in the annular groove.

6. The dust cover assembly of claim 5, wherein a first boss and a second boss on the inner wall of the opening form the annular groove.

7. The dust cover assembly of claim 6, wherein
a distal surface of the bushing that is distal from the second boss in an axial direction abuts against a surface of the first boss that faces the second boss, and
an end surface of the bushing that is proximal to the second boss in the axial direction abuts against a surface of the second boss that faces the first boss.

8. The dust cover assembly of claim 6, wherein
the bushing includes a bushing body and a flange connected to the bushing body, and
the flange protrudes radially inward.

9. The dust cover assembly of claim 1, wherein
the sealing member includes an annular main body portion and a sealing lip,
the sealing lip is connected to an inner wall surface of the annular main body portion,
the annular main body portion sealingly connects to the inner wall surface of the bushing, and
the sealing lip is configured to sealingly contact the steering shaft.

10. The dust cover assembly of claim 9, wherein
the sealing member includes a second support ring, a groove to which the second support ring is mounted being formed in the annular main body portion or the sealing lip; and
the second support ring is configured to provide support for the sealing lip.

11. The dust cover assembly of claim 10, wherein
the sealing member includes a first support ring,
an axial boss extending along an axial direction is disposed on the first support ring,
an end surface in an axial direction of the sealing lip includes a first groove recessed along the axial direction of the sealing lip,
the axial boss is disposed in interference with the first groove,
a radial boss extending along a radial direction of the first support ring is disposed on the first support ring,
an inner wall surface of an axial end opening of the annular main body portion includes a second groove recessed along a radial direction of the annular main body portion, and
the radial boss is disposed in interference with the second groove.

12. The dust cover assembly of claim 9, wherein
a first lip portion and a second lip portion are formed on a radially inner side of the sealing lip,
the first lip portion and the second lip portion are located at different ends in an axial direction of the sealing lip, and
the first lip portion and the second lip portion are configured to sealingly contact the steering shaft.

13. The dust cover assembly of claim 12, wherein
a shaft seal inter-lip groove is disposed between the first lip portion and the second lip portion in an inner wall surface of the sealing lip in the axial direction, and
the shaft seal inter-lip groove is recessed in the sealing member.

14. The dust cover assembly of claim 13, wherein
the sealing member includes a first support ring and a second support ring,
an end surface in the axial direction of the sealing lip is provided with a first groove recessed along the axial direction of the sealing lip,
the first groove is located in a radially outer side of the first lip portion,
an axial boss extending along an axial direction is disposed on the first support ring, and
the axial boss is disposed in interference with the first groove to support the first lip portion.

15. The dust cover assembly of claim 1, wherein the bushing is an integrally formed structure.

16. A steering shaft sealing structure, comprising:
a front cowl panel including a through-hole that is configured to receive a steering shaft,
the steering shaft, and
a dust cover assembly including:
a cover body, a first end of the cover body including an opening with an inner wall, wherein a cowl panel end of the cover body is sealingly connected to the front cowl panel;
a sealing member; and
a bushing disposed between the inner wall and the sealing member, wherein the sealing member is configured to sealingly interface with a circumferential surface of the steering shaft.

17. The steering shaft sealing structure of claim 16, further comprising:
a dust cover pressing plate, wherein
the cover body includes an outer cylinder body and an inner cylinder body with a cavity formed inside the outer cylinder body,
one end of the outer cylinder body is sealingly connected to the front cowl panel,
the inner cylinder body is connected to another end of the outer cylinder body and extends from an end surface of the other end of the outer cylinder body toward the front cowl panel,
the dust cover pressing plate is configured to press the end of the outer cylinder body onto the front cowl panel,
the bushing is press-fitted in the inner cylinder body, and
the sealing member is press-fitted in the bushing.

18. The steering shaft sealing structure of claim 17, wherein
the cover body includes a body sealing portion,
the body sealing portion is connected to the end of the outer cylinder body, and
the dust cover pressing plate is configured to press the body sealing portion onto the front cowl panel.

19. The steering shaft sealing structure of claim 16, wherein the steering shaft is an intermediate steering shaft.

20. A vehicle, comprising:
a steering shaft;
a steering intermediate shaft sealing structure, including:
a front cowl panel including a through-hole that is configured to receive the steering shaft,
a dust cover assembly, including:
a cover body, a first end of the cover body including an opening with an inner wall, wherein a cowl panel end of the cover body is sealingly connected to the front cowl panel;
a sealing member; and
a bushing disposed between the inner wall and the sealing member, wherein the sealing member is configured to sealingly interface with a circumferential surface of the steering shaft.
